(19) United States
(12) Patent Application Publication
(10) Pub. No.: US 2006/0206447 A1
(43) Pub. Date: Sep. 14, 2006

(54) Document managing apparatus

(75) Inventors: Noriyuki Komamura, Mishima-shi (JP); Nobuhiro Shimogori, Kawasaki-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/077,699

(22) Filed: Mar. 10, 2005

(51) Int. Cl. G06F 17/30

(52) U.S. Cl. 707/1

(57) ABSTRACT

A document managing apparatus has a display unit, an operation unit, a file managing information storage unit which stores file managing information about data files consisting documents to be managed, a document managing information storage unit which stores document managing information about the documents stored in the file managing information storage unit, by arranging in a specific order, and stores importance level data indicating the importance levels of relating to each document, and a display time changing unit which changes a display time of a document according to an importance level related to a document to be displayed, when displaying the documents on the display unit in the order arranged according to an instruction from the operation unit.

### BACKGROUND OF THE INVENTION

1. Field of the Invention

The present invention relates to a document managing apparatus and a document managing program, which manage data files constituting a document.

2. Description of the Related Art

Jpn. Pat. Appln. KOKAI Publication No. H5-54081 describes an apparatus, which electronically files documents and stores the filed document data. The apparatus searches for documents as follows. At the time of searching, data of documents is rearranged in order of search date so that the last-found document comes first. The documents are displayed in the rearranged order and accessed by the user. The user stops searching when a necessary document is displayed. By stopping the searching at the time when an object document is displayed, the user can access the object document.

However, if document data is previously arranged in a specific order and an object document is searched for by displaying documents in the specific order, as in the above apparatus, the user may miss an object document when quickly changing the documents. Once an object document is missed, the user must search for the document again from the beginning. Thus, the user needs much time to find an object document.

### BRIEF SUMMARY OF THE INVENTION

It is an object of the present invention to provide a document managing apparatus and a document managing program, which prevents missing of a necessary document by the user and increases searching efficiency.

According to an aspect of the present invention, there is provided a document managing apparatus comprising a display unit; an operation unit; a file managing information storage unit which stores file managing information about data files constituting documents to be managed; a document managing information storage unit which stores document managing information about the documents stored in the file managing information storage unit, by arranging in a specific order, and stores importance level data to indicate the importance levels of relating to each document; and a display time changing unit which changes a display time of a document according to an importance level related to a document to be displayed, when displaying the documents on the display unit in the order arranged according to an instruction from the operation unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic block diagram showing a configuration example of a document managing apparatus according to an embodiment of the present invention;

FIG. 2 shows a mouse according to the same embodiment;

FIG. 3 shows a display example of a document search screen according to the same embodiment;

FIG. 4 shows a relation between the documents managed by the document managing apparatus according to the same embodiment and the images displayed in an image display area;

FIG. 5 is a first file managing table according to the same embodiment;

FIG. 6 is a second file managing table according to the same embodiment;

FIG. 7 is a document managing table according to the same embodiment;

FIG. 8 is an updating document managing table according to the same embodiment;

FIG. 9 is an updated document managing table according to the same embodiment;

FIG. 10 is a color managing table according to the same embodiment;

FIG. 11 is a flowchart for explaining a document managing information registering process according to the same embodiment;

FIG. 12 is a flowchart for explaining an importance level adding process according to the same embodiment;

FIG. 13 is a flowchart for explaining an image generating process according to the same embodiment;

FIG. 14 is a flowchart for explaining a display process of a document search screen according to the same embodiment;

FIG. 15 is a flowchart for explaining a document map generating process according to the same embodiment;

FIG. 16 is a flowchart for explaining a document searching process according to the same embodiment; and

FIG. 17 is a table showing data added to documents according to the same embodiment.

### DETAILED DESCRIPTION OF THE INVENTION

Embodiments of the present invention will be explained in detail with reference to the accompanying drawings.

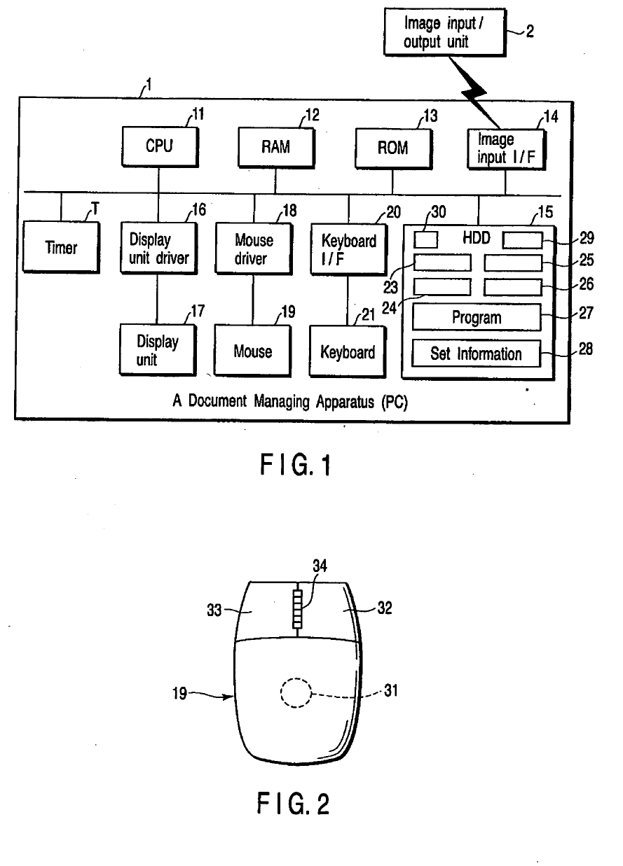

FIG. 1 is a schematic block diagram showing a configuration example of a document managing apparatus 1 according to an embodiment of the present invention.

The document managing apparatus 1 comprises a PC or the like connected to an image input/output unit 2. The image input/output unit 2 may be any equipment as long as it can provide an image to the document managing apparatus 1 as a PC. As the image input/output unit 2, a scanner, a digital multifunction peripheral (MFP) having a scanner, a digital camera, or a computer on a network (e.g., a WWW server) is assumed.

As shown in FIG. 1, the document managing apparatus 1 comprises a CPU 11, a RAM 12, a ROM 13, an image input interface (I/F) 14, a hard disk drive (HDD) 15, a display unit driver 16, a display unit 17, a mouse driver 18, a mouse 19, a keyboard interface (I/F) 20, a keyboard 21, and a timer T.

The CPU 11 controls the whole document managing apparatus 1. The CPU 11 realizes various functions by executing a control program stored in the ROM 13 or application programs stored in the HDD 15. The RAM 12 is a temporary memory to store working data. The ROM 13 is a nonvolatile memory having a previously stored basic control program to operate the document managing apparatus (PC) 1.

The image input interface 14 is an interface to input data such as an image from an external unit. In the configuration example shown in FIG. 1, the image input interface 14 serves as an interface to obtain an image from the image input/output unit 2. In FIG. 1, one image input interface 14 is shown, but more than one image input interface 14 can be provided in the document managing apparatus 1. Concretely, LAN, USB or an interface for wireless communication is assumed as the image input interface 14.

The HDD 15 is a storage composed of a magnetic disk or the like. The HDD 15 stores various data in a file format. Namely, data constituting an object document managed by the document managing apparatus 1 is stored in the HDD 15 as a file.

The HDD 15 has a first file managing table 23, a second file managing table 24, a document managing table 25, a color managing table 26, an additional data table 29, and a threshold value memory 30.

The first file managing table 23 and second file managing table 24 store managing information (file managing information) about data files constituting a document to be managed. The document managing table 25 stores managing information about a document to be managed (document managing information). The color managing table 26 stores information about a color related to a document to be managed (color managing information). The additional data table 29 stores information indicating additional data, when additional data such as an electronic tag is added to a document. The data tables 23-26 will be explained later in detail. A threshold value to be stored in the threshold value memory 30 is used to determine an importance level of a document described later. A predetermined numeric value is set as a default of the threshold value, or a certain value is set by the user as a threshold value.

The HDD 15 stores at least an application program (document managing program) 27 for operating a PC as the document managing apparatus 1, and set information 28.

The document managing program 27 comprises programs to make a PC execute various processing, such as registration of document managing information, calculation of importance level, generation of image, display of document search screen, generation of document map, and document searching. Namely, by executing the document managing program 27, a PC realizes a function of registering document managing information, a function of calculating importance level, a function of generating an image, a function of displaying a document search screen, a function of generating document map, and a function of searching documents.

The display unit driver 16 consists of a driving circuit to control the display contents of the display unit 17. The display unit driver 16 serves as an interface to output an image signal to be displayed in the display unit 17 to the display unit 17. The mouse driver 18 consists of a circuit to detect information input to the mouse 19. The mouse driver 18 detects movement of the mouse 19, input to the button of the mouse 19, or rotation amount of the wheel of the mouse 19. The mouse driver 18 informs the CPU 11 of a signal to indicate the movement of the mouse 19, the input to the button of the mouse 19, or the rotation amount of the wheel of the mouse 19.

The keyboard interface 20 detects information entered from the keyboard 21, and sends the information to the CPU 11. The keyboard 21 has character, numeral and symbol keys. An input from each key of the keyboard 21 is detected by the keyboard interface 20, 20 and sent to the CPU 11 as a signal to indicate the input key.

FIG. 2 shows a configuration example of the mouse 19.

As shown in FIG. 2, the mouse 19 has a movement 25 detecting device 31, a right button 32, a left button 33, and a wheel 34. The mouse 19 is placed and moved on a plane in the state shown in FIG. 2. The mouse 19 in the state shown in FIG. 2 is held by the user's hand. The user moves the mouse 19 on a plane in the state shown in FIG. 2, and clicks the right button 32, left button 33 and wheel 34 as needed.

The movement detecting device 31 converts movement of the mouse 19 on a plane into a signal. The movement detecting device 31 consists of a ball that rotates to follow the movement of the mouse 19, and a device to convert the movement of the ball into a signal. The movement detecting device 31 may be composed of an optical sensor to detect movement of the mouse 19 on a plane, and a device to convert movement of the mouse 19 detected by the optical sensor into a signal. The movement detecting device 31 is provided on the side to contact a plane surface in the state shown in FIG. 2. Namely, when the user moves the mouse 19 held in the state shown in FIG. 2, the movement detecting device 31 detects the movement of the mouse 19 on a plane surface. The signal to indicate the movement of the mouse detected by the movement detecting device 31 is sent to the mouse driver 18.

The right button 32 is provided at the upper right portion on the mouse 19 in the state shown in FIG. 2. The right button 32 is clicked with a forefinger or middle finger of the user, when the user holds the mouse 19 in the state shown in FIG. 2 by his right hand. The left button 33 is provided at the upper left portion on the mouse 19 in the state shown in FIG. 2. The left button 33 is clicked with a middle finger or ring finger of the user, when the user holds the mouse 19 in the state shown in FIG. 2 by his right hand.

The wheel 34 is a rotary member provided at the upper center portion on the mouse 19 in the state shown in FIG. 2. In the example shown in FIG. 2, the wheel 34 is provided between the right button 32 and left button 33. The wheel 34 is clicked with a forefinger, middle finger or ring finger of the user holding the mouse 19 in the state shown in FIG. 2.

The wheel 34 is arranged to turn only in a fixed direction. In the example shown in FIG. 2, the wheel 34 turns from this side to that (upward from the lower side in FIG. 2), and vice versa (upward from the lower side in FIG. 2). The wheel 34 can be tilted laterally to get the same function.

The timer T generates time information. The CPU 11 counts various time based on the time information generated by the timer T. The CPU 11 obtains the time information generated by the timer T if necessary, when counting the various time.

Next, explanation will be given on a document display screen (document search screen) to display documents managed by the document managing apparatus 1.

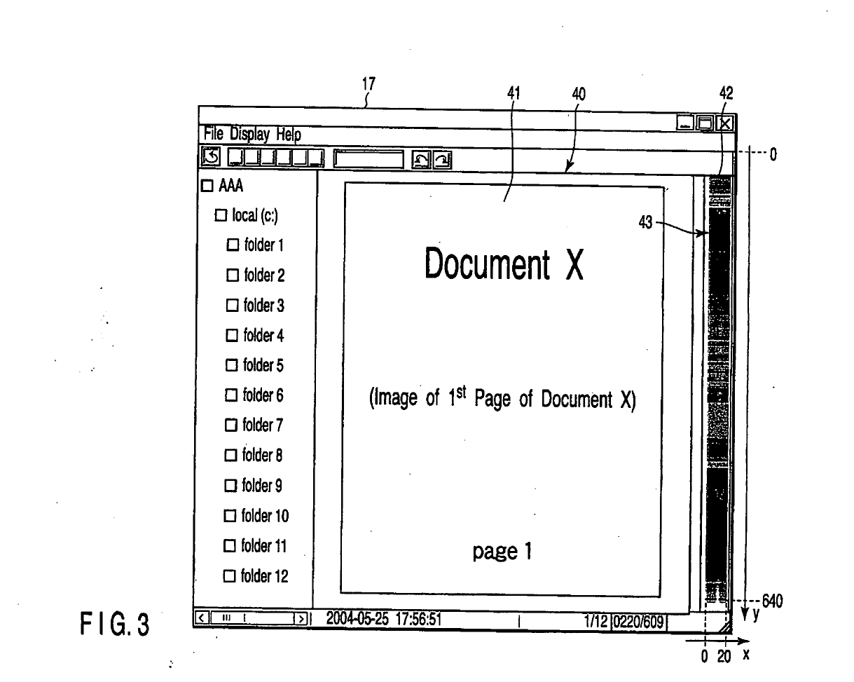

FIG. 3 shows a display example of the document search screen (document display screen) of the display unit 17 of the document managing apparatus 1.

The document managing apparatus 1 displays the document search screen 40 in a display window on the display unit 17. The document search screen 40 displays images of each page constituting a document managed by the document managing apparatus 1 in units of a page, as shown in FIG. 3. By referring to the image displayed on the document search screen 40 as shown in FIG. 3, the user searches a desired document.

In the example shown in FIG. 3, the document search screen 40 includes an image display area 41, a document map (a search bar) 42 and an arrow 43, in addition to a tool bar comprising various operation keys.

The image display area 41 is substantially a central area of the display window as a document search screen 40 displayed in the display unit 17. The image display area 41 is used to display images of one or more pages constituting a document, in units of a page according to the user's operation.

The document map 42 is displayed in the right end area of the document search screen 40. The document map 42 includes a bar (line) to indicate a document managed by the document managing apparatus 1 by stacking in time series. This indicates the stacked state of the documents managed by the document managing apparatus 1. On the document map 42 shown in FIG. 3, the uppermost bar indicates a document having the latest document time (the latest document), and the lowermost bar indicates a document having the oldest document time (the oldest document). Namely, on the document map 42 shown in FIG. 3, a bar stacked at a higher position indicates a newer document, and a bar stacked at a lower position indicates an older document.

The arrow 43 is displayed in an area adjacent to the document map 42 on the document search screen 40. The arrow 43 indicates the position on the document map 42 of the document, to which the image displayed in the image display area 41 belongs. Namely the arrow 43 indicates the position of the bar on the document map 42 indicting the document being displayed.

On the document map 42, each bar corresponding to each document is displayed in a color corresponding to each document. A color corresponding to a document displayed on the document map 42 is set for each folder to save a data file constituting a document. In this case, a document saved in the same folder is indicated by the same color. A document saved in a different folder is indicated by a different color. Thus, the user can instantly identify a folder storing each document. A color of a bar corresponding to each document displayed on the document map 42 may be set for each extension of a document file or each application to open a document file. It is also permitted to determine a color by a document creator, or according to a method of acquiring data or classification made by the user.

Next, explanation will be given on changing of images to be displayed in the image display area 41 of the document search screen 40.

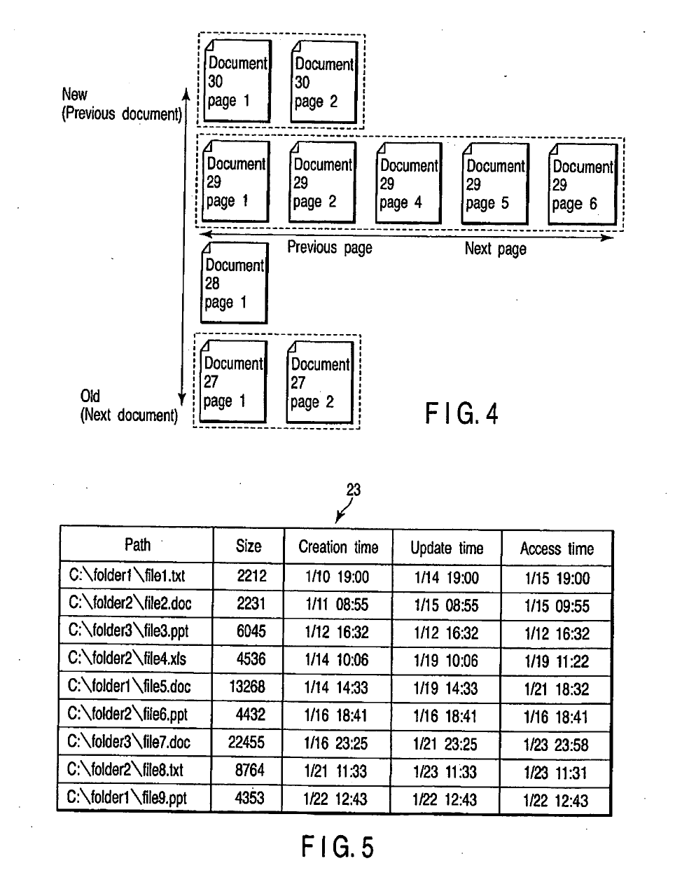

FIG. 4 shows a relation between the documents managed by the document managing apparatus 1 and the images displayed in the image display area 41.

The documents managed by the document managing apparatus 1 consist of one or more pages as shown in FIG. 4. The images displayed in the image display area 41 of the document search screen 40 shown in FIG. 3 can be changed according to the input from the mouse 19 or keyboard 21. The images displayed in the image display area 41 can be changed in units of document or page.

The document managing apparatus 1 manages documents in time series based on creation time or update time of a document, as shown in FIG. 4. The order of documents is reflected also on the order of the stacked display of bars corresponding to each document on the document map 42. Therefore, a bar for each document is displayed in time series on the document map 42, as shown in FIG. 3.

The document managing apparatus 1 manages each document in order of pages, as shown in FIG. 4.

The document managing apparatus 1 changes a document to be displayed on the document search screen 40, according to an instruction in the vertical direction (the up/down direction in FIG. 3) entered from the mouse 19 or keyboard 21. The document managing apparatus 1 changes a page to be displayed on the document search screen, according to the instruction in the lateral direction (the left/right direction in FIG. 3) entered from the mouse 19 or keyboard 21.

Namely, when the user carries out an operation in the vertical direction through the mouse 19 or keyboard 21, the document managing apparatus 1 changes a document to be displayed in the image display area 41 of the document search screen 40. As a result, a representative image (e.g., an image of first page of document) of the document changed according to the user's operation in the vertical direction is displayed in the image display area 41 of the document search screen 40. When the user carries out an operation in the lateral direction through the mouse 19 or keyboard 21, the document managing apparatus 1 changes a page to be displayed in the image display area 41 of the document search screen 40. As a result, an image of the page changed according to the user's operation in the lateral direction is displayed in the image display area 41 of the document search screen 40.

Now, explanation will be given on the case of changing an image to be displayed in the image display area 41 of the document search screen 40 in units of document.

Documents are changed by the user's instruction to change documents entered from an input device such as the mouse 19 or keyboard 21. Here, as described above, a document as an image to be displayed in the image display area 41 is assumed to change by an instruction in the vertical direction (the up/down direction). A document is changed according to an input to the up/down cursor keys (the up key and down key) of the keyboard 21, or an instruction in the vertical direction entered from a pointing device such as the mouse 19. In this embodiment, a document is changed according to the rotation of the wheel 34 of the mouse 19.

When a document is changed by the above operations, an image of a first page is displayed as a representative image of that document in the image display area 41 of the document search screen 40. Namely, each time a document is changed by the mouse 19 or keyboard 21, an image of a first page of each document will be sequentially displayed in the image display area 41. It is permitted to set a specific page of a document as a representative image.

Namely, when changing a representative image (a first page image) of a document to be displayed in the image display area 41, the user instructs to change the document by an input device such as the mouse 19 and keyboard 21. Then, the document managing apparatus 1 changes an image of a corresponding page of a document to be displayed in time series in the image display area 41.

Next, explanation will be given on the case of changing an image to be displayed in the image display area 41 of the document search screen 40 by units of page.

Pages are changed by the user's instruction to change pages entered from an input device such as the mouse 19 or keyboard 21. Here, as described above, a page as an image to be displayed in the image display area 41 is assumed to change by an instruction in the lateral direction. A page is changed according to an input to the left/right cursor keys (the right key and left key) of the keyboard 21. The page changing may be done by tilting the wheel 34 of the mouse 19.

When a page is changed by the above operations, an image of each page constituting a document being displayed is displayed in the image display area 41 of the document search screen 40. Namely, when displaying a specific page of a specific document in the image display area 41, the user first displays an image of a first page of a desired document in the image display area 41 by changing a document as explained above. In this display state, the user instructs to change a page through the mouse 19 or keyboard 21. Then, an image of each page constituting a document being displayed will be sequentially displayed in the image display area 41 in the order of pages.

Next, explanation will be given on various data tables 23-26 for managing a document in the document managing apparatus 1 configured as described above.

In the document managing apparatus 1, data constituting each document to be managed is stored as a file in the HDD 15. A data file constituting a document stored in the HDD 15 is managed by the first file managing table 23 and second file managing table 24. A document corresponding to a file stored in the HDD 15 is managed by the document managing table 25. A color of a bar indicating each document on the document map-42 of the document search screen 40 is managed by the color managing table 26.

Explanation will be given on the first file managing table 23 and second file managing table 24.

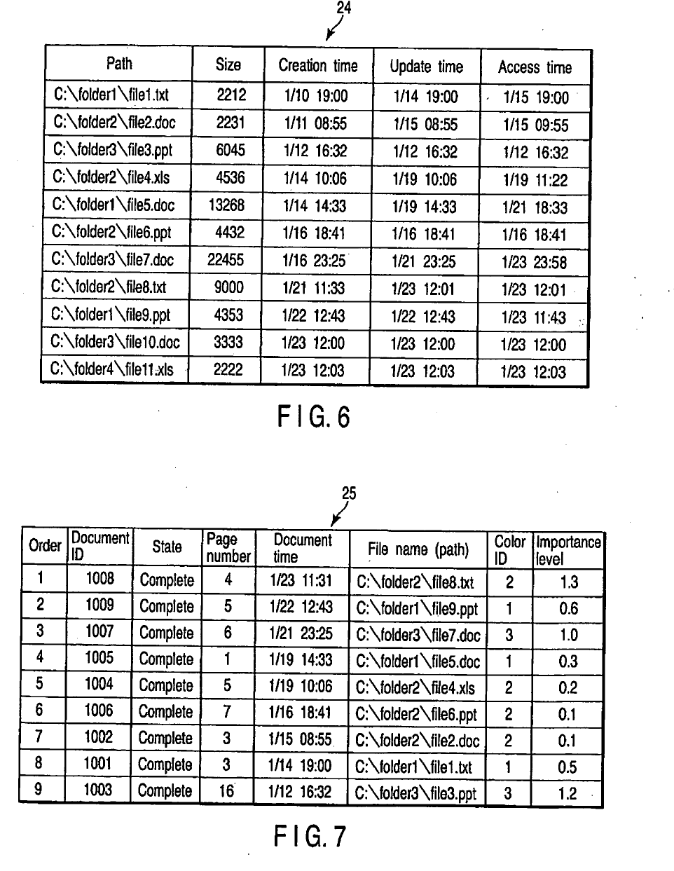

FIG. 5 shows a configuration example of the first file managing table 23. FIG. 6 shows a configuration example of the second file managing table 24.

The first file managing table 23 and second file managing table 24 store the managing information about files as a document to be managed by the document managing apparatus 1.

As shown in FIG. 5 and FIG. 6, the first file managing table 23 and second file managing table 24 are configured to store path, size, creation time, update time, and access time as file managing information.

As a path, information indicating a file name of a corresponding file is stored as well as a drive name and folder name, in which the corresponding file exists. As size, a data size of a corresponding file is stored. As creation time, the date and time of creating a corresponding file is stored. As update time, the date and time of updating a corresponding file are stored. As access time, the last date and time of accessing a corresponding file are stored.

The first file managing table 23 stores each file managing information at a point in the past time. The point in the past time mentioned here is the last time that the document managing apparatus 1 is started up. Contrarily, the second file managing table 24 displays a list of current files. Therefore, the second file managing table 24 is updated at any time according to the updating and addition of a file.

For example, when the document managing apparatus 1 is started up, the information about the second file managing table 24 at that point of time is saved as a first file managing table and a new second file managing table 24 is created (updated). The second file managing table 24 stores the managing information about a newly added file and updated file. In other words, the difference between the file at the previous startup time and the file at the present startup time appears as a difference between the first file managing table 23 and second file managing table 24. In this embodiment, the file update state (newly registered or updated) is determined by the difference between the first file managing table 23 and second file managing table 24.

Now, as an example of registration of new file, it is assumed that the document managing apparatus 1 obtains a document composed of pages of image through the image input interface 14. In this case, the document data obtained through the image input interface 14 is stored in the HDD 15 as a newly registered file. In this time, a field to store the managing information about a corresponding file is added to the second file managing table 24. The path, size, creation time, update time and access time are stored in that field as the newly registered file managing information. In this case, the information about the first file managing table 23 is held without being updated.

As an example of updating a file, it is assumed that a file whose managing information exists in the second file managing table 24 is updated. In this case, the updated file is saved by writing over an existing file in the HDD 15. In this time, the managing information about that file such as size, update time and access time in the second file managing table 24 is rewritten based on the updated file. In this case, the information about the first file managing table 23 is held without being updated.

Next, the document managing table 25 will be explained.

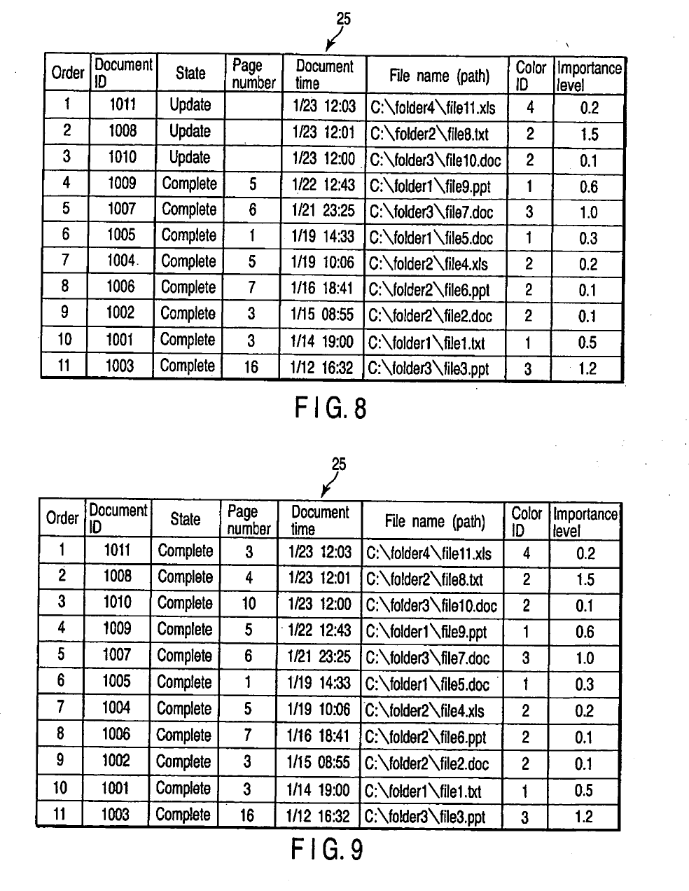

FIG. 7, FIG. 8 and FIG. 9 show a configuration example of the document managing table 25.

The document managing table 25 is a table to manage files managed by the first file managing table 23, as documents. As shown in FIG. 7, FIG. 8 and FIG. 9, the document managing table 25 stores order, document ID, state, number of pages, document time, file name, color ID, and importance level as document managing information.

As an order, information indicating a display order of each document is stored. As described above, each document is displayed in time series based on the document time in document searching screen 40 as shown in FIG. 3. Therefore, the document managing table 25 manages the order of documents according to the order of document time.

As document ID, a unique ID information given to each document to identify that document is stored.

As state, information indicating the processing state of each document is stored. For example, information indicating “update” and “complete” states is stored. The “complete” indicates the state that the updating (or registration) of a certain document is completed. The “update” indicates the state that a certain document is queued for updating (or registration).

As number of pages, information indicating the number of pages of a certain document is stored. The number of pages is decided when the state of a corresponding document becomes “complete”.

As document time, a creation time or an update time of each document is stored. For example, an update time of a file corresponding to a document managed on the first file managing table 23 is stored.

As file name, information indicating a file corresponding to a certain document is stored. For example, a drive name, a folder name and a file name for a file corresponding to a certain document are stored.

As color ID, information indicating a color to display the information indicating each document is stored. The color ID is a unique ID information given to each color to identify that color. Information indicating an actual color corresponding to the color ID is displayed on the color managing table 26.

As importance level, a numerical value to determine an importance level is stored. As an importance level, a predetermined importance level point is added to the document managing table 25, each time a document is updated, displayed or printed. An importance level calculating process for adding an importance level point will be explained later in detail.

The document managing table 25 is updated in a document managing information registering process described later. For example, nine documents are managed on the document managing table 25 shown in FIG. 7. In this state, a document of ID “1008” is updated, and documents of ID “1010” and “1011” are newly added. In this case, in the document managing information registering process, three documents in the “update” state (the documents ID “1008”, “1010” and “1011”) are registered on the document managing table 25 sown in FIG. 7. In this case, the document managing table 25 shown in FIG. 8 is created.

On the document managing table 25 shown in FIG. 8, three documents ID “1008”, “1010” and “1011” are stored in the “update” state. As shown in FIG. 8, an image generating process is executed sequentially for the documents set to the “update” state on the document managing table 25. Namely, documents are set to the “complete” state after the image generating process is executed. Therefore, when the image generating process is completed for the three documents ID “1008”, “1010” and “1011”, the document managing table 25 shown in FIG. 8 is rewritten to the document managing table 25 shown in FIG. 9.

The number of pages of each document is decided by the number of images generated in the image generating process. Thus, on the document managing table 25, the number-of-pages column is left blank for documents in the “update” state as shown in FIG. 8. Therefore, as for a document changed from “update” to “complete”, the number of images generated in the image generating process is stored as the number of pages.

Next, the color managing table 26 will be explained.

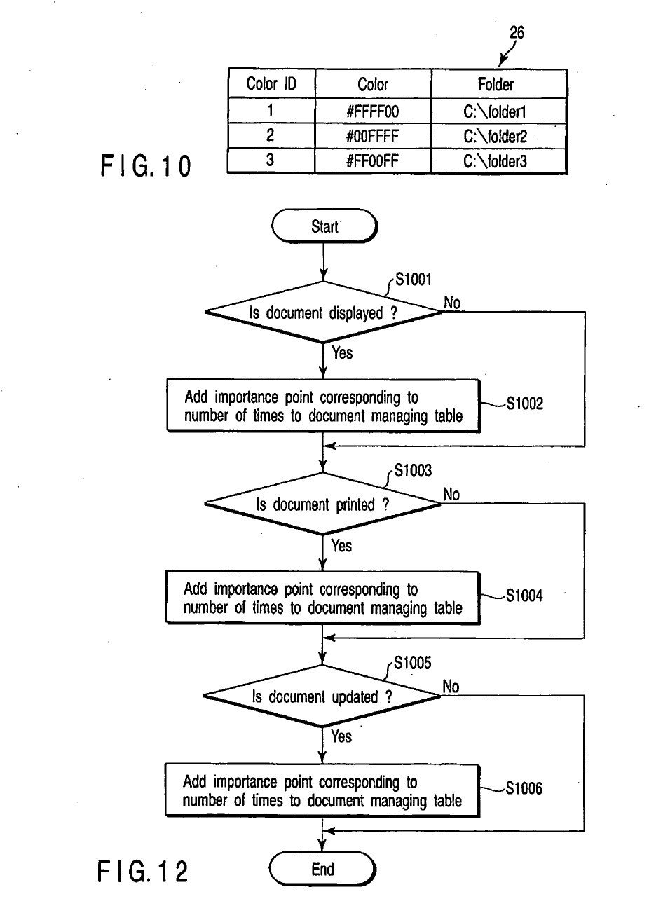

FIG. 10 shows a configuration example of the color managing table 26.

The color managing table 26 relates a color ID, color (information indicating an actual color) and a folder. As described above, on the document managing table 25, a color corresponding to each document is indicated by a color ID. Therefore, a color corresponding to each document is identified by a color ID on the document managing table 25 and a color in the color managing table 26. A color corresponding to each document means a color of a bar corresponding to each document displayed on the document map 42 of the document search screen 40.

In this embodiment, a color of a bar corresponding to each document displayed on the document map 42 of the document search screen 40 is set for each folder. Therefore, a color ID and color corresponding to each folder are displayed in the color managing table 26, as shown in FIG. 10. When a color of a bar corresponding to each document displayed on the document map 42 is set for each extension of a file or each application to open a document, the color ID and color corresponding to that extension or application are stored in the color managing table 26.

Next, explanation will be given on a document managing information registering process in the document managing apparatus 1.

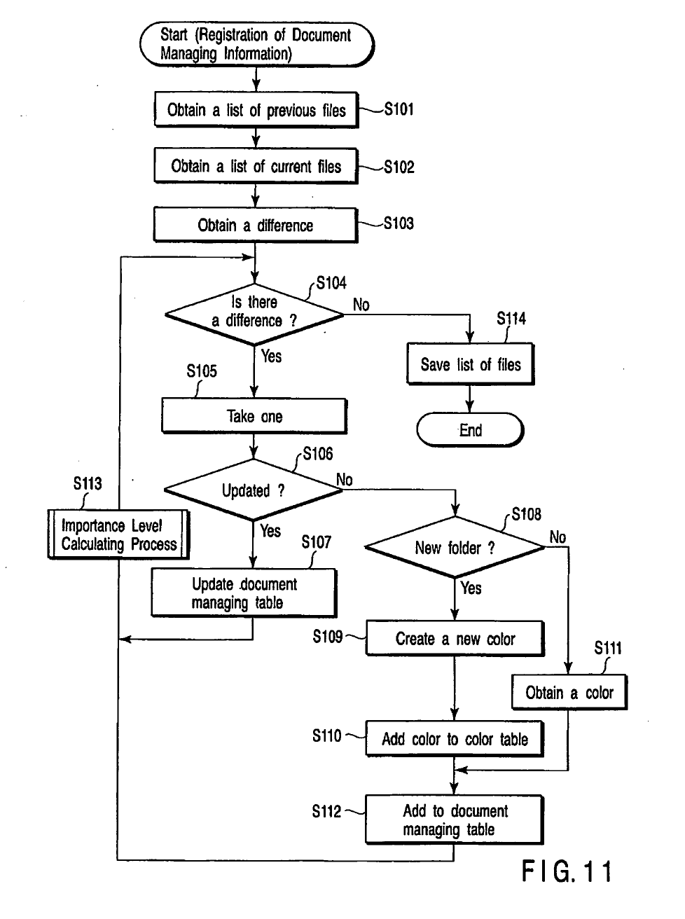

FIG. 11 is a flowchart for explaining a document managing information registering process in the document managing apparatus 1.

First, when the document managing apparatus 1 is started up, or a PC as the document managing apparatus 1 starts the document managing program 27, the CPU 11 reads the first file managing table 23 from the HDD 15 as the information about a previous file (step S101). After reading the first file managing table 23, the CPU 11 reads the second file managing table 24 from the HDD 15, as the information about a current file (step S102).

After reading the first file managing table 23 and second file managing table 24, the CPU 11 performs a differential file detecting process that detects the difference between the file managing information about all files stored in the first file managing table 23 (the previous file information) and the file managing information about all files stored in the second file managing table 24 (the current file information) (step S103). The information about the differential file detected in the differential file detecting process is temporarily saved in the RAM 12, for example.

The differential file detecting process extracts a file that is updated or newly added in a period from the creation time of previous file information to the present time. In this embodiment, the access time is not detected as a differential file.

Namely, a file that does not exist in the previous file information and exists in the current file information, that is, a file that exists only in the second file managing table 24 is identified as a newly added file.

A file having an update time in the current file information is different from the previous file information, that is, a file having an update time different in the first file managing table 23 and second file managing table 24 is identified as an updated file.

A file that does not exist in the current file information and exists in the previous file information, that is, a file that exists only in the first file managing table 23 is identified as a deleted file.

For example, in the differential file detecting process in the first file managing table 23 shown in FIG. 5 and second file managing table 24 shown in FIG. 6, three files having names of “file8.txt”, “file10.doc” and “file11.x1s” are detected as a differential file.

In this case, the file (“file8.txt”) having the path “C:\folder2\file8.txt” has a different update time. Therefore, the file having the name “file8.txt” is identified as an updated file.

The file (“file10.doc”) having the path “C:\folder3\file10.doc” and file (“file11.xls”) having the path “C:\folder4\file11.x1s” exist only in the second file managing table 24. Therefore, a file having the name “file10.doc” and file having the name “file11.x1s” are identified as a newly added file.

When a differential file is detected in the above differential file detecting process (step S104, YES), the CPU 11 sequentially reads the managing information about the detected differential file and update the document managing table 25 (step S105-S112). This updating of the document managing table 25 is repeated until the processing for all the differential files detected in the differential file detecting process is completed.

Namely, when there is a differential file detected in the differential detecting process (step S104, YES), the CPU 11 reads the detected differential file managing information one by one (step S105). Each time the CPU 11 reads one differential file, the CPU 11 determines whether that differential file is an updated file (a file with a changed update time) or a newly added file (step S106).

When the CPU 11 determines that the read differential file is an updated file (step S106, YES), the CPU 11 updates the document managing information corresponding to that file on the document managing table 25 (step S107).

When the CPU 11 determines that the read differential file is not an updated file, or the read differential file is a newly added file (step S106, NO), the CPU 11 checks whether that differential file is a file stored in a newly created folder (a new folder) (step S108). In this check, whether the folder is newly created or not is determined by checking whether the color of the folder storing that differential file is managed by the color managing table 26. Namely, a folder whose color is set in the color managing table 26 is identified as an existing folder.

For example, as to the file having the path “C:\folder3\file10.doc”, a color is already assigned to the folder “C:\folder3” in the color managing table shown in FIG. 10. In this case, the folder “C:\folder3” is identified as not a new folder. Contrarily, as for the file having the path “C:\folder4\file11.x1s”, a color is not assigned to the folder “C\folder4” in the color managing table shown in FIG. 10. In this case, the folder “C:\folder4” is identified as a new folder.

When the CPU 11 determines that the folder is a new folder in the above process (step S108, YES), the CPU 11 generates a color to be assigned to that new folder (step S109). For example, a new folder is given a new color that is not assigned to other folders. A unique color ID is assigned to the newly generated color. After generating a color to be assigned to the new folder, the CPU 11 adds color information to relate the color of the new folder to the color ID, to the color managing table 26 (step S110), as color information for the new folder.

After adding the color information for the new folder having the differential file, the CPU 11 executes a new document adding process for adding the document managing information corresponding to the differential file, to the document managing table 25 (step S112).

If the CPU 11 determines that the folder is not a new folder in the above process (step S108, NO), the CPU 11 obtains a color ID to be assigned to the folder that stores the file in the color managing table 26 (step S111). In this case, the CPU 11 executes a new document adding process for adding the document managing information corresponding to the differential file to the document managing table 25 (step S112).

In the new document adding process of steps S111 and S112, a document managing information is generated for a newly added file by referring to the second file managing table 24 and color managing table 26.

For example, the update time of the differential file is used for a document time in the document managing information. The path of the differential file is used for a file name in the document managing information. A newly generated unique information is used for a document ID in the document managing information, to discriminate from existing documents. The color ID of the color related to the folder storing the differential file is used for a color ID in the document managing information. The number-of-pages column in the document managing information is left blank, and the state in the document managing information is set to “update”. Because the number of pages in the document managing information will be decided, when image data is generated from the differential file in an image generating process described later.

When the document managing table is updated (step S107) and a new document is added (step S112), an importance level calculating process will be executed (step S113). The importance level calculating process will be described later with reference to FIG. 12.

If a differential file is not detected in the differential file detecting process or the processing for all the differential files detected in the differential file detecting process are completed (step S104, NO), the CPU 11 stores the information stored in the second file managing table 24 in the first file managing table 23, as file information about the present startup time (step S114). Therefore, the first file managing table 23 stores the file information used when the differential file is detected (on the present startup time). Thus, the information stored in the first file managing table 23 can be used as previous file information on the next startup time.

In the above process, the state of the document managing information corresponding to updated files and document managing information for newly added files are registered as “update” on the document managing table 25. Documents in the “update” state will be changed to the “complete” state in the document image generating process described later, and the number of pages will be decided.

The importance level calculating process will now be explained. For the importance level calculating process, the number of times the document obtained as a difference by the CPU 11 in the above process is displayed, printed and updated is previously stored in a specified area of the RAM 12, and an importance point of 0.1 is added to the importance level according to the number of times of display, printing and updating. It is also permitted to prioritize the importance points of display, printing and updating of documents.

FIG. 12 is a flowchart for explaining the importance level adding process.

The CPU 11 determines whether a specified application is started by operating the mouse 19, and a document obtained as a difference in step S105 is displayed in the display unit 17 (step S1001). When the document is displayed (step S1001, YES), the CPU 11 adds the importance point corresponding to the number of display times to the document managing table 25. For example, when the number of display times is 1, 0.1 is added to the importance level of that document, and when the number of times of display is 2, 0.2 is added to the importance level of that document (step S1002).

If the document is not displayed (step S1001, NO) or when the importance point corresponding to the number of display times of the document is added (step S1002), the CPU 11 determines whether the document is printed or not (step S1003). When the document has been printed (step S1003, YES), the CPU 11 adds the importance point corresponding to the number of print times to the document managing table 25. For example, when the number of print times is 1, 0.1 is added to the importance level of that document (step S1004).

If the document is not printed (step S1003, NO) or when the importance point corresponding to the number of print times of the document is added (step S1004), the CPU 11 determines whether the document is updated or not (step S1005). When the document has been updated (step S1005, YES), the CPU 11 adds the importance point corresponding to the number of update times to the document managing table 25. For example, when the number of update times is 1, 0.1 is added to the importance level of that document (step S1006).

For example, 1.3 is stored as an importance level related to the document ID “1008” on the document managing table 25 shown in FIG. 7. If the document ID “1008” has been updated after displayed in the display unit 17, 0.2 is added and the importance level becomes 1.5. After the importance level adding process, the importance level related to the document ID “1008” on the document managing table 25 becomes 1.5, as shown in FIG. 8.

Next, a document image generating process will be explained.

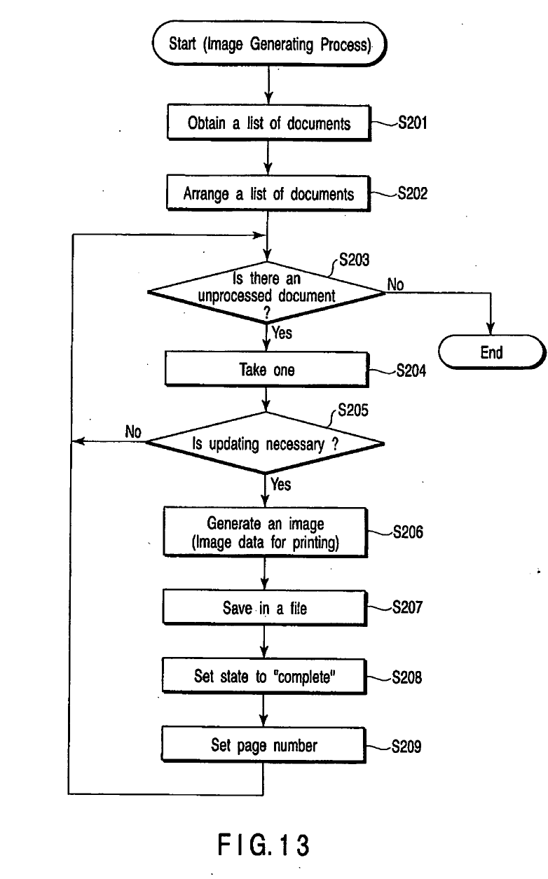

FIG. 13 is a flowchart for explaining the image generating process.

In the document managing information registering process, the document managing information corresponding to the files updated and newly registered on the document managing table 25 is registered as an “update” state. These “update” state files indicate that a display image is not generated. Thus, it is necessary to generate a display image for a document in the “update” state. A process of generating a display image for such a document is called an image generating process.

Namely, after the registration of the document managing information is completed, the CPU 11 executes the image generating process for generating a display image. When the image generating process is started, the CPU 11 reads the managing information about all documents from the document managing table 25 (step S201). After reading the managing information about all documents from the document managing table 25, the CPU 11 arranges the document managing information based on the document time included in the managing information about each document (step S202). Then, on the document managing table 25, the managing information about all documents are rearranged in the order of document time (in time series). For example, in the example shown in FIG. 8, the latest three documents are set to the “update” state.

After arranging the document managing information on the document managing table 25 based on the document time, the CPU 11 checks whether there is a document for which the image generating process is not executed (an unprocessed document) (step S203). If an unprocessed document is found, the CPU 11 reads the document managing information about the unprocessed document one by one (step S204).

After reading the document managing information about one unprocessed document, the CPU 11 checks whether the state included in the document managing information about that document is “update” or not (step S205). When the state is “update” (step S205, YES), the CPU 11 generates an image for displaying that document (step S206).

In the image generating process, a bitmap image of each page constituting the document is generated as an image for displaying the document. In this embodiment, the image data for displaying the document is created as an image data for printing. Data of each document is composed of various types of data such including text and image data.

The document managing apparatus 1 manages documents composed of various types of data. Thus, the document managing apparatus 1 generates data of each page constituting a document as image data for printing. Usually, various types of data used for various application programs are generated as printing images in each application program. For example, when a document is text data, an image for displaying that document is generated as a printing image by an application program of word processor.

After generating a display image data in the above image generating process, the CPU 11 saves the image of each page constituting the document (an image data for displaying each page) in the HDD 15 as an image data file (step S207). Then, the image data files equivalent to the pages of the document are saved in the HDD 15. After saving the image data files of the pages of the document in the HDD 15, the CPU 11 changes the state of the document included in the document managing information about the document managing table 25 to “complete” (step 208). Further, the CPU 11 specifies the number of pages from the number of files generated as image data, and sets the number of pages as one of the document managing information about the document on the document managing table 25 (step S209).

When all unprocessed documents have been processed, or the state of all documents on the document managing table 25 are changed to the “complete” state (step S203, NO), the CPU 11 finishes the image generating process.

As described above, in this embodiment, the image data for displaying each document is generated as one file for each page of the document. The image data for displaying each document may be of any form including TIFF and PDF. In this embodiment, JPEG format is used.

As to each file of image data for displaying each page, a file name is specified by a document ID and page, number. For example, a displaying image data file is saved as a file named “documentID-pagenumber.jpg”.

For example, a document “C:\folder4\file11.x1s” is composed of three pages of image on the document managing table 25 shown in FIG. 8. In this case, in the displaying image generating process for the document “C:\folder4\file11.x1s”, image data for displaying three pages (three JPEG format image data files) is generated.

The document “C:\folder4\file11.x1s” has a document ID “1011” as shown in FIG. 8. Thus, as image data for displaying the document “C:\folder4\file11.x1s”, three files named “1011-001.jpg”, “1011-002.jpg” and “1011-003.jpg” are generated.

In this case, the state and number of pages of the document managing information about the document ID “1011” on the document managing table 25 shown in FIG. 8 are set to “complete” and “3”, respectively. FIG. 9 shows an example of the document managing table 25 after the image generating process is completed for the document managing table 25 in the state shown in FIG. 8.

The image generating process may be executed in parallel with other processes. Namely, the image generating process may be executed in a background of other processes. For example, when there are many documents in the “updated” state, or there are many pages of a document in state of “updated” the image generating process may take much time. Therefore, even during execution of the image generating process, the CPU 11 may execute a display process of the document search screen 40 as described later.

Next, explanation will be given on a displaying process when displaying the document search screen (a display window for searching documents) 40.

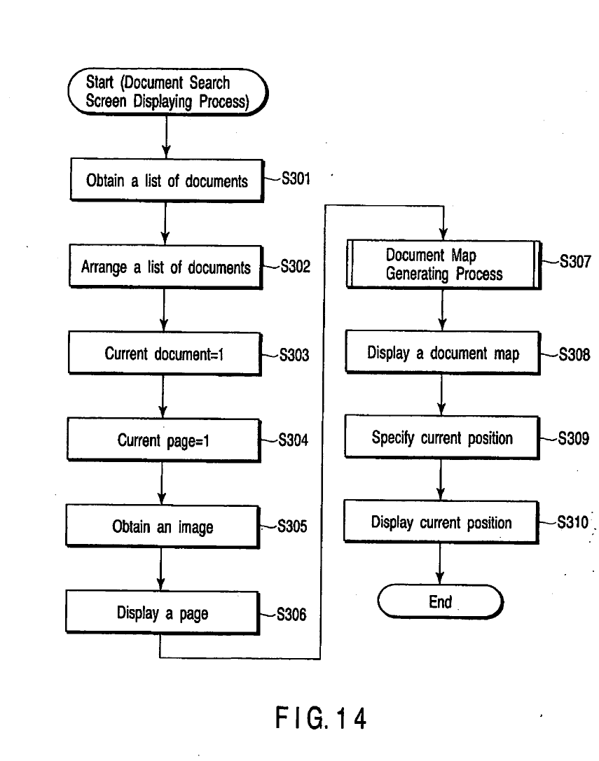

FIG. 14 is a flowchart for explaining a displaying process of the document search screen 40.

When displaying (starting) the document search screen 40, the CPU 11 first reads the managing information about all documents stored on the document managing table 25 (step S301). After reading the managing information about all documents stored on the document managing table 25, the CPU 11 arranges the document managing information in the order of document time, latest to oldest (in time series) (step S302).

After arranging all document managing information in the timer series, the CPU 11 reserves a current document (displayed document) storing area to store the information indicating a document being displayed in the RAM 12. After reserving the current document storing area, the CPU 11 sets the information indicating the latest document in the current document storing area (step S303). It is assumed here that the “order” stored as one of the document managing information in the above document managing table 25 is set in the current document storing area, as information indicating the current document. In other words, the CPU 11 indicates a document being displayed (a current document) by the “order” given to each document.

Further, the CPU 11 reserves a current page (a displayed page) storing area to store information indicating the number of pages of a document being displayed in the RAM 12. After reserving the current page storing area, the CPU 11 sets information indicating a representative page (a first page in this embodiment) of a document in the current page storing area (step S304). It is assumed here that the number of pages is set in the current page storing area, as information indicating the current page.

Namely, the CPU 11 displays a representative page (a first page) of the latest document as an initial display image. Thus, the CPU 11 sets the current document to “1” and a current page to “1”. After setting the current document to “1” and the current page to “1”, the CPU 11 obtains a file of image data for displaying a corresponding page (an image of page “1.” of a document having an order “1”) (step S305).

In the image obtaining process, a file of image data of the page to be displayed is specified by referring to the document managing table 25. Namely, the CPU 11 obtains a document ID corresponding to the “order” set as the current document (“1” in this case) by referring to the document managing table 25. After obtaining a document ID of the current document, the CPU 11 specifies a file of image data consisting of a document ID and page number of the current document by the “page number” (“1” in this case) set as the current page.

For example, in the example of the document managing table 25 shown in FIG. 9, a document ID having an order “1” is “1011”. In this case, an image file of the first page of the document ID “1011” is saved by the name “1011-001.jpg”. Therefore, when the current document is “1” and the current page is “1”, the CPU 11 refers to the document managing table 25 shown in FIG. 9, and specifies the file “1011-001.jpg” as an image data file.

After obtaining an image data file by the above image obtaining process, the CPU 11 displays the image data of that file in an image display area 41 of the document search screen 40 (step S306). After displaying the image data of the obtained file in the image display area 41, the CPU 11 executes a document map generating process for generating the document map 42 to display all documents in time series (step S307). The document map generating process will be explained later in detail.

After generating the document map 42 on the document map generating process, the CPU 11 displays the generated document map 42 in a specified display area on the document search screen 40 (step S308). After displaying the document map 42 on the document search screen, the CPU 11 specifies the position of a current document on the document map 42 (step S309). After specifying the position of a current document, the CPU 11 displays the arrow 43 to indicate the position of a current document on the document map 42 (step S310).

In the above document search screen displaying process, an initial screen is displayed as the document search screen 40 in the display window of the display unit 17.

Next, the document map generating process will be explained.

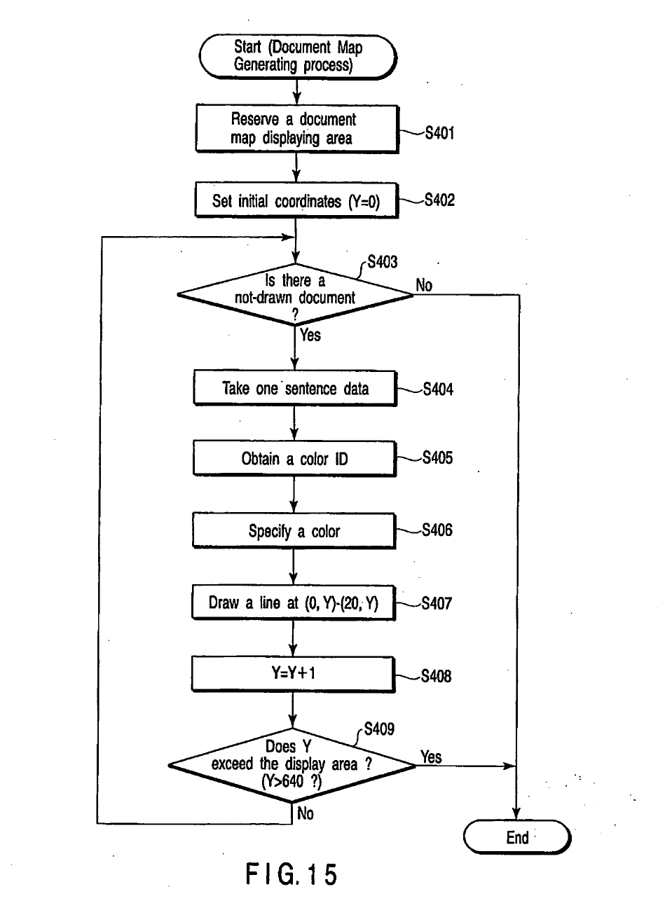

FIG. 15 is a flowchart for explaining the document map generating process.

When a process of generating the document map 42 is started, the CPU 11 reserves a display an area for displaying the document map 42 on the document search screen 40 (step S401). The display an area for displaying the document map 42 is previously set. In step S401, the CPU 11 displays the display area reserved for the document map 42 in a color as an initial value such as white.

For example, the display an area for displaying the document map 42 is set as an area of 20 pixels wide and 640 pixels height at the right end of the document search screen 40. Here, the display an area for displaying the document map 42 is assumed to be a rectangular area having coordinate values (X, Y) indicated by four points of (0. 0), (20, 0), (0, 640) and (20, 640).

After reserving the display an area for displaying the document map 42 on the document search screen 40, the CPU 11 sets an initial coordinate value to start drawing (step S402). Here, a Y-coordinate of the initial coordinate value is assumed to set to “0” (Y=0) as the uppermost end of the display area for displaying the document map 42.

After setting the initial coordinate value, the CPU 11 reads document managing information from the document managing table 25 in numerical order, younger to older. Namely, The CPU 11 checks whether a document having a bar not drawn in the display an area for displaying the document map 42 (a not-drawn document) exists on the document managing table 25. When a not-drawn document exists on the document managing table 25 (step S403), the CPU 11 reads the managing information about the not-drawn document having the fastest “order” (step 404).

After reading the document managing information, the CPU 11 specifies a color ID assigned to that document (step 405). After specifying the color ID of the document, the CPU 11 refers to the color managing table 26, and decides an actual color corresponding to the color ID of the document (step S406). The decided color is used to draw a bar (line) to indicate that document on the document map 42.

After deciding a color of the bar indicating the document, the CPU 11 draws the bar (line) in that color indicating the document at a position of the current coordinate value in the display an area for displaying the document map 42 (step S407). Here, a bar to indicate a document is assumed to be a line having the one-pixel width (height) in the Y direction. In this case, for a first document, a bar having the 1-pixel width (height) is drawn at a position of the initial coordinate values of Y ((0, Y) to (20, Y)) in the area for displaying the document map 42.

After drawing the bar to indicate the document, the CPU 11 sets “Y=Y+1”, and increases the coordinate value in the Y direction by 1 pixel (step 408). After increasing the coordinate value in the Y direction by 1 pixel, the CPU 11 checks whether the coordinate value in the Y direction exceeds the area for displaying the document map 42. When it is confirmed by this check that the coordinate value in the Y direction exceeds the area for displaying the document map 42 (step S409, YES), the CPU 11 finishes the process of generating the document map 42.

If it is confirmed that the coordinate value in the Y direction does not exceed the area for displaying the document map 42 (step S409, NO), the CPU 11 returns to step S403. The CPU 11 repeats steps S403-S409 until no not-drawn document remains in the area for displaying the document map 42. Namely, steps S403-S409 are repeatedly executed for all documents managed by the document managing table 25.

By the above processing, the document map 42 on which a bar indicating each document is stacked in time series in a color corresponding to each document, is generated.

Next, a document searching process will be explained.

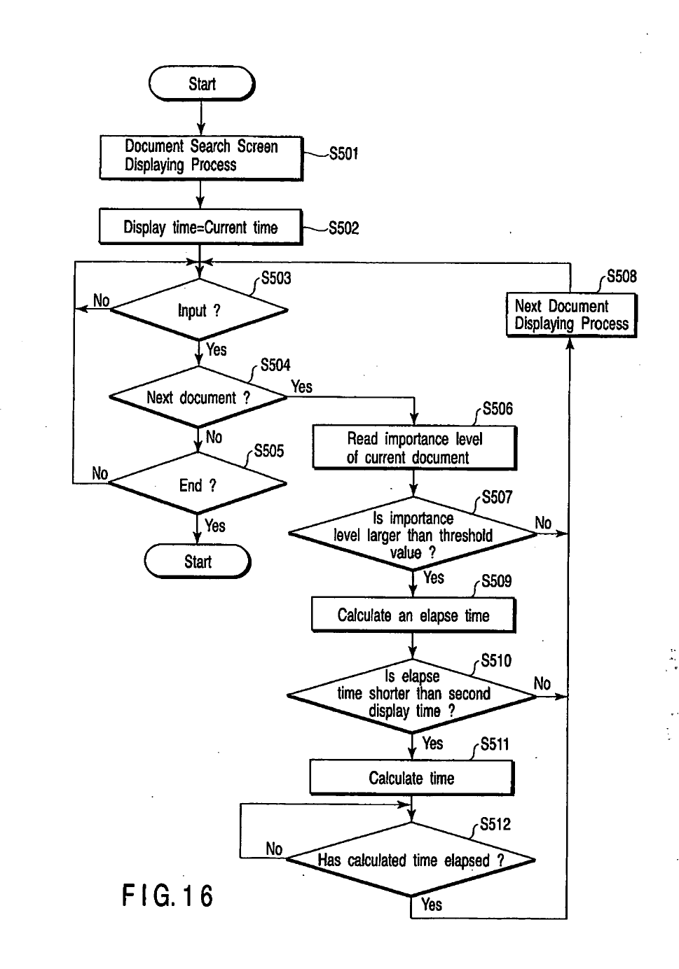

FIG. 16 is a flowchart for explaining the document searching process (a display time changing process).

First, it is assumed that the document search screen 40 displays an image of a first page of a document having the latest document time, according to the display process of the document searching screen (step S501). The CPU 11 obtains a current time when an image is displayed, from the time information generated by the timer T, and sets the current time as a display time in the RAM 12, for example (step S502).

In this state, the CPU 11 waits for an input from the user through the mouse 19 or the cursor key of the keyboard 21 (step S503). The CPU 11 will detect the input from the mouse 19 or keyboard 21.

When detecting the input from the mouse 19 or keyboard (step S503, YES), the CPU 11 checks whether the input is for changing the current image display to the next document or not (step S504). Concretely, the CPU 11 determines whether the input is made by the rotation of the wheel of the mouse 19 or the operation of the up/down cursor key.

When NO in the above check, the CPU 11 determines whether the input instruction is for termination or not (step S505). When the instruction is for termination (step S505, YES), the CPU 11 turns off the document search screen 40 and terminates the processing. If the instruction is not for terminal (step S505, NO), the CPU 11 executes a process corresponding to the input, and returns to step S503 and waits for an input.

When YES in step S504, that is, when the input is for changing to the next document, the CPU 11 reads the importance level related to the displayed document from the document managing table 25 (step S506). Then, the CPU 11 determines whether the importance level is larger than the threshold value preset in the threshold value memory 30 (step S507). In this way, the CPU 11 determines whether the displayed document is important or not.

When the CPU 11 determines that the displayed document is not important (NO in step S507), the CPU 11 displays the image of the next document in the display unit 17 (step S508). Concretely, the display unit 17 displays an image of a first page of a document whose document time managed on the document managing table 25 is one before the current display document. Therefore, when the CPU 11 sequentially changes the images displayed in the display unit 17 by the wheel of the mouse 19 being turned, an unimportant document is displayed only for a moment (a first display time) in the display unit 17.

The displayed document is important (step 5507, YES), the CPU 11 obtains the time information generated by the timer T, and calculates the elapse time from that time and the display time set in the RAM 12 to the time when the image is displayed (step 5509).

The CPU 11 determines whether the calculated elapse time is shorter than the time for displaying the important document for which the calculated elapse time is preset (hereinafter, referred to as a second display time) (step S510). This second display time for displaying an important document is assumed to be preset to 2 seconds, for example. The second display time may be set freely by the user. Namely, it is displayed as the time longer than document changing time.

When the elapse time is shorter than the second display time, the CPU 11 calculates the time or the difference between the second display time and elapse time (step S511). Then, the CPU 11 determines whether the calculated time has elapsed or not based on the time information generated by the timer T (step S512). When the calculated time has elapsed, the CPU 11 displays an image of the next document in the display unit 17 (step S508). Therefore, even if the user quickly turns the wheel of the mouse 19, the document can be displayed in the display unit 17 within at least 2 seconds (the second display time) if it is an important document.

When the elapse time is not shorter than the second display time, or the elapse time is longer than the second time, the CPU 11 displays an image of the next document in the display unit 17 (step S508). In this case, the document is displayed for enough time (2 or more seconds as the second display time). Therefore, the user will not miss the document.

In this embodiment, when the user searches for a managing object document on the document search screen by using the document managing apparatus 1, even if the user sequentially changes documents by using the wheel of the mouse 19 (or the up/down cursor key), an important document is surely displayed for a certain time, for example, 2 seconds. Therefore, the user will not miss an important document during the document searching. As the user does not miss a desired document during the document searching, it is unnecessary to repeat the searching from the beginning. Therefore, the document managing apparatus 1 can increase the document searching efficiency.

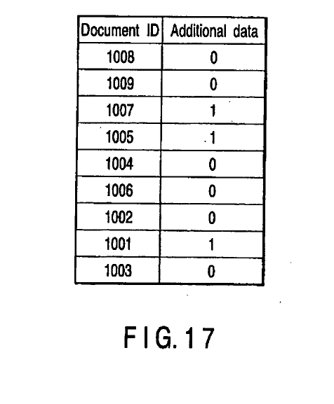

The importance level may be obtained not only by counting the numbers of document update times, display times and print times, but also by calculating preset numeric values when additional data as an electric tag is related to a document ID. FIG. 17 is a table showing a configuration example of additional data related to a document ID. As shown in FIG. 17, “1” is stored in an additional data area when a document includes additional data, and “0” is stored in an additional data area when a document includes no additional data. The document managing table 25 may manage an additional data area to check existence of additional data related to a document ID. When additional data is related to a document, a numeric value “1” for example preset as an importance point is added to an importance level. With this configuration, by setting to add 1 point to an importance level when additional data is related to a document, a document related to additional data is displayed as an importance document for longer than a certain time during the document searching.

In the embodiment described hereinbefore, it is assumed that the function of embodying the invention is previously recorded in the apparatus. It is also permitted to download a similar function from a network into the apparatus, or to install a recording medium containing a similar function in the apparatus. Any type of recording medium including CD-ROM may be used, as long as it can record a program and can be read by the apparatus. A function given by the installation or downloading may realize the function by cooperating with an operating system (OS) in the apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A document managing apparatus comprising:
a display unit;
an operation unit;
a file managing information storage unit which stores file managing information about data files constituting documents to be managed;
a document managing information storage unit which stores document managing information about the documents stored in the file managing information storage unit, by arranging in a specific order, and stores importance level data to indicate the importance levels of relating to each document; and
a display time changing unit which changes a display time of a document according to an importance level related to a document to be displayed, when displaying the documents on the display unit in the order arranged according to an instruction from the operation unit.

2. The document managing apparatus according to claim 1, further comprising:
a threshold value memory which stores a threshold value to change a display time; and
a threshold value determining unit which determines whether an importance level related to a document to be displayed on the display is larger than a threshold value stored in the threshold value memory,
wherein the display time changing unit changes a display time to a first display time when the threshold value determining unit determines that an importance level related to the document to be displayed is lower than the threshold value, and a second display time longer than the first display time when the threshold value determining unit determines that an importance level related to the document to be displayed is larger than the threshold value.

3. The document managing apparatus according to claim 2, further comprising:
a timer to count time;
an elapse time calculator which calculates time elapsed from the time when the document is displayed on the display unit;
a time determining unit which determines whether the elapse time is shorter than the second display time; and
a time calculator which calculates the time as a difference, when the time determining unit determines that the elapse time is shorter than the second display time;
wherein the display time changing unit changes the display to the next document after the calculated time elapses, when the threshold value determining unit determines that an importance level related to the document to be displayed is larger than the threshold value, and the time determining unit determines that the elapse time is shorter than the second display time, upon reception of an instruction to change a display to the next document from the control unit during displaying a document.

4. The document managing apparatus according to claim 1, wherein the importance level is obtained based on at least one of the number of document update times, display times and print times.

5. The document managing apparatus according to claim 4, wherein a predetermined number is added to the importance level, when a document includes additional data.

6. The document managing apparatus according to claim 5, wherein the additional data is data to indicate an electric tag.

7. The document managing apparatus according to claim 1, wherein the importance level is obtained based on the total of the document update times, display times and print times.

8. The document managing apparatus according to claim 1, wherein the operation unit has a mouse having a wheel, and the documents arranged in the specific order in the display unit are displayed in synchronization with the rotation of the wheel.

9. A document managing program to be executed by a computer, comprising:
a file managing function of managing file managing information about data files constituting documents to be managed;
a document managing function of managing document managing information about the documents to be managed by the file managing function, by arranging in a specific order, and managing importance level data indicating the importance of relating to each document; and
a display time changing function of changing a display time of a document according to an importance level related to a document to be displayed, when displaying the documents in the arranged order according to a given instruction.

10. The document managing program according to claim 9, further comprising:
a threshold value determining function of determining whether the importance level related to the document to be displayed is larger than a threshold value to change the display time,
wherein the display time changing function changes the display time to a first display time when the threshold value determining function determines that the importance level related to the document to be displayed is lower than the threshold value, and a second display time longer than the first display time when the threshold value determining function determines that the importance level related to the document to be displayed is larger than the threshold value.

11. The document managing program according to claim 10, further comprising:
an elapse time calculating function of calculating time elapsed from the time when the document is displayed;
a time determining function of determining whether the elapse time is shorter than the second display time; and
a time calculating function of calculating the time as a difference, when the time determining function determines that the elapse time is shorter than the second display time,
wherein the display time changing function changes the display to the next document after the calculated time elapses, when the threshold value determining function determines that an importance level related to the document to be displayed is larger than the threshold value, and the time determining function determines that the elapse time is shorter than the second display time, upon reception of an instruction to change display to the next document during displaying a document.

12. The document managing program according to claim 9, wherein the importance level is obtained based on at least one of the number of document update times, display times and print times.

13. The document managing program according to claim 12, wherein a predetermined number is added to the importance level, when a document includes additional data.

14. The document managing program according to claim 13, wherein the additional data is data to indicate an electric tag.

15. The document managing program according to claim 9, wherein the importance level is obtained based on the total of the document update times, display times and print times.

16. A method of displaying on searching documents in a managing apparatus, comprising:
managing file managing information about data files constituting documents to be managed;
managing the document managing information about documents to be managed, by arranging in a specific order, and managing importance level data indicating the importance of relating to each document; and
changing a display time of a document according to an importance level related to a document to be displayed, when displaying the documents in the arranged order according to a given instruction.

17. The method of displaying, according to claim 16, further comprising:
determining whether the importance level related to the document to be displayed is larger than a threshold value to change the display time,
wherein the display time is changed to a first display time when the importance level related to the document to be displayed is smaller than the threshold value, and a second display time longer than the first display time when the importance level related to the document to be displayed is larger than the threshold value.

18. The method of displaying, according to claim 17, further comprising:
calculating time elapsed from the time when the document is displayed;
determining whether the elapse time is shorter than the second display time; and
calculating the time as a difference, when the elapse time is shorter than the second display time,
wherein the display is changed to the next document after the calculated time elapses, when an importance level related to the document to be displayed is larger than the threshold value, and the elapse time is shorter than the second display time, upon reception of an instruction to change display to the next document during displaying a document.

19. The document managing apparatus according to claim 4, wherein the importance level is added when a given specific keyword exists.
